(19) United States
(12) Patent Application Publication
(10) Pub. No.: US 2024/0036414 A1
(43) Pub. Date: Feb. 1, 2024

(54) ARRAY SUBSTRATE AND LIQUID CRYSTAL DISPLAY PANEL

(71) Applicant: Shenzhen China Star Optoelectronics Semiconductor Display Technology Co., Ltd., Shenzhen, Guangdong (CN)

(72) Inventors: Juncheng XIAO, Shenzhen, Guangdong (CN); Ji LI, Shenzhen, Guangdong (CN); Jing LIU, Shenzhen, Guangdong (CN); Xiaojin HE, Shenzhen, Guangdong (CN); Yun YU, Shenzhen, Guangdong (CN); Fen LONG, Shenzhen, Guangdong (CN); Yingchun ZHAO, Shenzhen, Guangdong (CN)

(73) Assignee: Shenzhen China Star Optoelectronics Semiconductor Display Technology Co., Ltd., Shenzhen, Guangdong (CN)

(21) Appl. No.: 17/611,628

(22) PCT Filed: Oct. 29, 2021
(86) PCT No.: PCT/CN2021/127433

§ 371 Date: May 4, 2023

(30) Foreign Application Priority Data
Oct. 25, 2021 (CN) 202111243075.9

(51) Int. Cl. G02F 1/1362

(52) U.S. Cl. CPC G02F 1/136286; G02F 1/136218

(57) ABSTRACT

The present application discloses an array substrate and a liquid crystal display panel. array substrate includes: a substrate, a data wiring layer, wherein the data wiring layer is disposed on the substrate, the data wiring layer includes data lines, the data lines are disposed along first direction and are spaced at intervals; an electrical field shielding layer, wherein the electrical field shielding layer is disposed on the substrate, the electrical field shielding layer and the data wiring layer are in different layers, and the electrical field shielding layer includes shielding electrodes. The shielding electrodes are disposed to right correspond to the data lines one by one.

### FIELD OF INVENTION

The present application relates to a field of display technologies, especially to an array substrate and a liquid crystal display panel.

### BACKGROUND OF INVENTION

A liquid crystal display panel comprises an array substrate, a color filter substrate, and a liquid crystal layer disposed between the array substrate and the color filter substrate. The array substrate comprises gate lines, data lines, pixel electrodes, and thin film transistors. The perpendicular gate lines and data lines define pixel regions, and the thin film transistors and the pixel electrodes are formed in the pixel regions. The gate lines are configured to provide the thin film transistors with switch-on signals, and the data lines are configured to provide the pixel electrodes with data signals. Controlling rotation degrees of the liquid crystal layer achieves grayscale display.

However, charges on the data lines generate an electrical field to interfere with the pixel electrodes to cause negative effects such as light leakage and crosstalk.

### SUMMARY OF INVENTION

### Technical Issue

The present application provides an array substrate and a liquid crystal display panel that can shield an electrical field generated by charges on data lines to prevent interference with pixel electrodes causing negative effects such as light leakage and crosstalk.

### Technical Solution

In a first aspect, the present application provides an array substrate, comprising:
a substrate;
a data wiring layer disposed on the substrate, wherein the data wiring layer comprises a plurality of data lines, and the data lines are disposed along a first direction and are spaced at intervals; and
   an electrical field shielding layer disposed on the substrate, wherein the electrical field shielding layer comprises a plurality of shielding electrodes, an orthographic projection of the shielding electrodes on the substrate at least partially coincides with an orthographic projection of the data lines on the substrate.

In the array substrate of the present application, the shielding electrodes are disposed to right correspond to the data lines.

In the array substrate of the present application, the electrical field shielding layer further comprises a plurality of scan lines, and the scan lines are disposed along a second direction and are spaced at intervals; and
the shielding electrodes comprises a plurality of sub-shielding electrodes disposed along the second direction and spaced at intervals, and one of the sub-shielding electrodes is disposed between adjacent two of the scan lines.

In the array substrate of the present application, the electrical field shielding layer further comprises a plurality of first connection electrodes, the first connection electrodes are disposed along the second direction and are spaced at intervals; one of the first connection electrodes is disposed between adjacent two of the scan lines, and the sub-shielding electrode between adjacent two of the scan lines is connected to the first connection electrode.

In the array substrate of the present application, the data wiring layer further comprises at least one second connection electrode, the second connection electrode and the data lines are staggered; the second connection electrode comprises a plurality of sub-connection electrodes, the sub-connection electrodes are disposed along the second direction and are spaced at intervals, and an orthographic projection of the sub-connection electrode on the electrical field shielding layer is located between adjacent two of the sub-shielding electrodes, and the adjacent two of the sub-shielding electrodes are connected through the sub-connection electrode.

In the array substrate of the present application, a voltage of a signal on the shielding electrode is less than a minimum value of a voltage of a signal on the data line, or a voltage of a signal on the shielding electrode is greater than a maximum value of a voltage of a signal on the data line.

In the array substrate of the present application, the voltage of the signal of the shielding electrode is −20 volt to 0 volt, or, the voltage of the signal of the shielding electrode is 14 volts to 30 volts.

In the array substrate of the present application, the substrate, the electrical field shielding layer, and the data wiring layer are sequentially stacked on one another.

In the array substrate of the present application, the substrate, the data wiring layer, and the electrical field shielding layer are sequentially stacked on one another.

In a second aspect, the present application also provides a liquid crystal display panel, comprising:
the array substrate as described above;
an alignment substrate disposed opposite to the array substrate; and
a liquid crystal layer disposed between the array substrate and the alignment substrate;
wherein the array substrate comprises:
a substrate;
a data wiring layer disposed on the substrate, wherein the data wiring layer comprises a plurality of data lines, and the data lines are disposed along a first direction and are spaced at intervals; and
an electrical field shielding layer disposed on the substrate, wherein the electrical field shielding layer comprises a plurality of shielding electrodes, an orthographic projection of the shielding electrodes on the substrate at least partially coincides with an orthographic projection of the data lines on the substrate.

In the liquid crystal display panel of the present application, the shielding electrodes are disposed to right correspond to the data lines.

In the liquid crystal display panel of the present application, the electrical field shielding layer further comprises a plurality of scan lines, and the scan lines are disposed along a second direction and are spaced at intervals; and
the shielding electrodes comprises a plurality of sub-shielding electrodes disposed along the second direction and spaced at intervals, and one of the sub-shielding electrodes is disposed between adjacent two of the scan lines.

In the liquid crystal display panel of the present application, the electrical field shielding layer further comprises a plurality of first connection electrodes, the first connection electrodes are disposed along the second direction and are spaced at intervals; one of the first connection electrodes is disposed between adjacent two of the scan lines, and the sub-shielding electrode between adjacent two of the scan lines is connected to the first connection electrode.

In the liquid crystal display panel of the present application, the data wiring layer further comprises at least one second connection electrode, the second connection electrode and the data lines are staggered; the second connection electrode comprises a plurality of sub-connection electrodes, the sub-connection electrodes are disposed along the second direction and are spaced at intervals, and an orthographic projection of the sub-connection electrode on the electrical field shielding layer is located between adjacent two of the sub-shielding electrodes, and the adjacent two of the sub-shielding electrodes are connected through the sub-connection electrode.

In the liquid crystal display panel of the present application, a voltage of a signal on the shielding electrode is less than a minimum value of a voltage of a signal on the data line, or a voltage of a signal on the shielding electrode is greater than a maximum value of a voltage of a signal on the data line.

In the liquid crystal display panel of the present application, the voltage of the signal of the shielding electrode is −20 volt to 0 volt, or, the voltage of the signal of the shielding electrode is 14 volts to 30 volts.

In the liquid crystal display panel provided by the present application, the substrate, the electrical field shielding layer, and the data wiring layer are sequentially stacked on one another.

In the liquid crystal display panel of the present application, the substrate, the data wiring layer, and the electrical field shielding layer are sequentially stacked on one another.

### Advantages

The array substrate and the liquid crystal display panel provided by the present application, by disposing the shielding electrodes to right correspond to the data lines, shield an electrical field generated by charges on data lines to prevent interference with pixel electrodes causing negative effects such as light leakage and crosstalk. Furthermore, because shielding electrodes are disposed to right correspond to the data lines, a pixel aperture rate can be improved.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic structural view of an array substrate provided by an embodiment of the present application;

FIG. 2 is a schematic cross-sectional view of an array substrate shown in FIG. 1 along a direction of a line A-A′;

FIG. 3 is a schematic cross-sectional view of the array substrate shown in FIG. 1 along a direction of a line B-B′;

FIG. 4 is a schematic voltage-time chart of signals inputted into shielding electrodes and data lines in the array substrate provided by the embodiment of the present application;

FIG. 5 is another schematic voltage-time chart of signals inputted into shielding electrodes and data lines in the array substrate provided by the embodiment of the present application;

FIG. 6 is another schematic structural view of the array substrate provided by the embodiment of the present application; and

FIG. 7 is a schematic structural view of the liquid crystal display panel provided by the embodiment of the present application.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application. It should be understood that the specific embodiments described here are only used to illustrate and explain the present application, and are not used to limit the present application. The terms “first”, “second”, etc. in the description and claims of the present application and the above-mentioned drawings are used to distinguish different objects, not to describe a specific order.

The array substrate and the liquid crystal display panel provided by the present application, by disposing the shielding electrodes to right correspond to the data lines, shield an electrical field generated by charges on data lines to prevent interference with pixel electrodes causing negative effects such as light leakage and crosstalk. The detailed description is given below. It should be explained that the description order of the following embodiment is not a limitation on the preferred order of the embodiment.

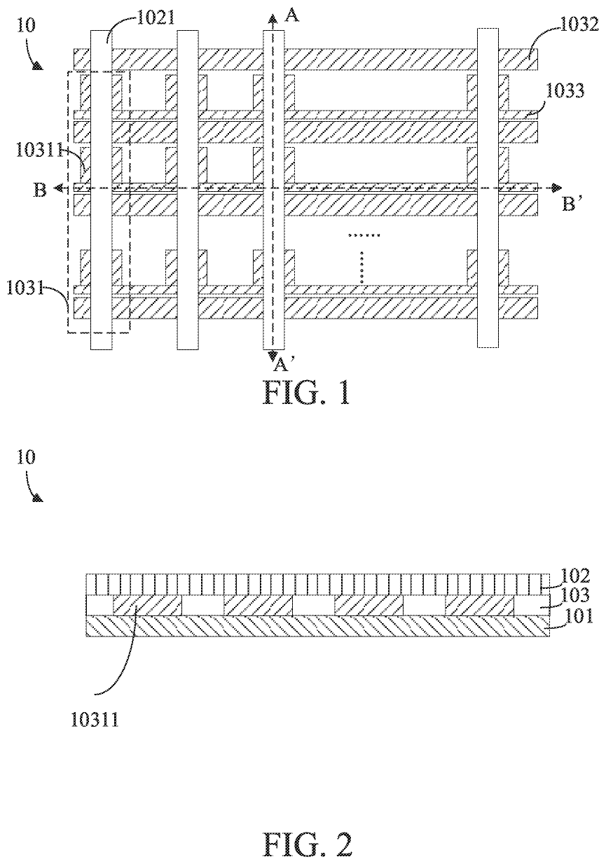

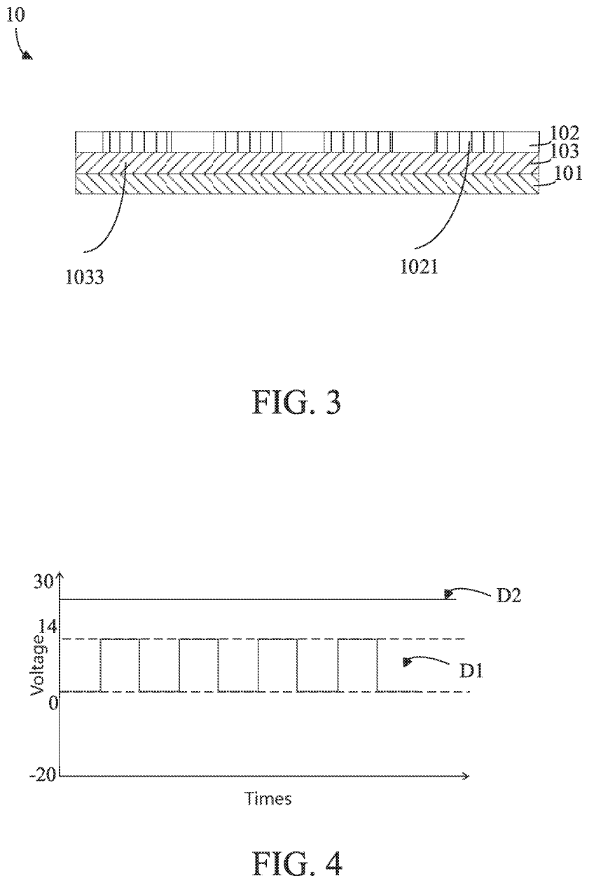

With reference to FIGS. 1, 2, and 3, FIG. 1 is a schematic structural view of an array substrate provided by an embodiment of the present application; FIG. 2 is a schematic cross-sectional view of an array substrate shown in FIG. 1 along a direction of a line A-A′; FIG. 3 is a schematic cross-sectional view of the array substrate shown in FIG. 1 along a direction of a line B-B′ With reference to FIGS. 1, 2, and 3, the array substrate provided by the embodiment of the present application 10 comprises a substrate 101, a data wiring layer 102 and an electrical field shielding layer 103. The data wiring layer 102 is disposed on the substrate 101. The electrical field shielding layer 103 is disposed on the substrate 101. The data wiring layer 102 and the electrical field shielding layer 103 are located in different layers. The data wiring layer 102 comprises a plurality of data lines 1021. The data lines 1021 are disposed along a first direction and are spaced at intervals. The electrical field shielding layer 103 comprises a plurality of shielding electrodes 1031. An orthographic projection of the shielding electrodes 1031 on the substrate 101 at least partially coincides with an orthographic projection of the data lines 1021 on the substrate 101.

In an embodiment, the shielding electrodes 1031 correspond to the data lines 1021 one by one, and an orthographic projection of each of the shielding electrodes 1031 on the substrate 101 at least partially coincides with an orthographic projection of a corresponding one of the data lines 1031 on the substrate 101. It can be understood that the shielding electrodes 1031 are disposed to right correspond to the data lines 1021.

It should be explained that the shielding electrodes 1031 are disposed to right correspond to the data lines 1021 one by one. Namely, the orthographic projection of the shielding electrode 1031 on the substrate 101 at least partially coincides with the orthographic projection of the data line 1021 on the substrate 101. It can be understood that a data wiring layer 102 needs to be disposed on the array substrate 10 for forming the data lines 1021. The embodiment of the present application, by disposing the shielding electrodes 1031 to right correspond to the data lines 1021, can shield an electrical field generated by charges on the data lines 1021 to prevent interference with pixel electrodes causing negative effects such as light leakage and crosstalk. Furthermore, because the shielding electrodes 1031 are disposed to right correspond to the data lines 1021, a pixel aperture rate can be improved.

In an embodiment, the substrate 101, the electrical field shielding layer 103 and the data wiring layer 102 are sequentially stacked on one another. Namely, the electrical field shielding layer 103 is disposed under the data wiring layer 102. In another embodiment, the substrate 101, the data wiring layer 102, and the electrical field shielding layer 103 are sequentially stacked on one another. Namely, the electrical field shielding layer 103 is disposed above the data wiring layer 102. Namely, the present application can dispose relative locations of the electrical field shielding layer 103 and the data wiring layer 102 according actual processes.

In an embodiment, a width of the shielding electrode 1031 is greater than a width of the data line 1021. Namely, the present application can set the width of the shielding electrode 1031 to be greater than the width of the data line 1021 to guarantee that the shielding electrodes 1031 are not broken easily. In another embodiment, the width of the shielding electrode 1031 is less than the width of the data line 1021. Namely, the present application can set the width of the shielding electrode 1031 to be less than the width of the data line 1021 to further improve a pixel aperture rate. In still another embodiment, the width of the shielding electrode 1031 is equal to the width of the data line 1021. Namely, the present application can set the width of the shielding electrode 1031 to be equal to the width of the data line 1021 to guarantee that the shielding electrodes 1031 are not easily broken and simultaneously improve the pixel aperture rate.

In an embodiment, pixels on the array substrate 10 can adopt a 4 domains pixel design. In another embodiment, pixels on the array substrate 10 can adopt an 8 domains pixel design.

In an embodiment, signals inputted into the shielding electrodes 1031 on the array substrate 10 can be direct current signals. In another embodiment, signals inputted into the shielding electrodes 1031 on the array substrate 10 can be alternating current signals.

In an embodiment, a material of the shielding electrodes 1031 on the array substrate 10 can be metal. For example, the material of the shielding electrodes 1031 on the array substrate 10 can be copper or aluminum. In another embodiment, the material of the shielding electrodes 1031 on the array substrate 10 can be indium tin oxide.

With reference to FIGS. 1, 2, and 3, in FIGS. 1, 2, and 3, the substrate 101, the electrical field shielding layer 103 and data wiring layer 102 are sequentially stacked on one another, and a width of the shielding electrode 1031 is greater than a width of the data line 1021. The array substrate 10 as shown in FIGS. 1 to 3 is taken as an example for explanation as follows.

In the embodiment of the present application, the electrical field shielding layer 103 further comprises a plurality of scan lines 1032. The scan lines 1032 are disposed along a second direction and are spaced at intervals. The scan lines 1032 and the shielding electrodes 1031 are disposed in a same layer. It should be explained that the array substrate 10 not only needs to dispose the data wiring layer 102 on the array substrate 10 to form the data lines 1021 but also needs to dispose a scan wiring layer on the array substrate 10 to form the scan lines 1032. The embodiment of the present application forms the scan lines 1032 and the shielding electrodes 1031 on the same layer to lower an entire thickness of the array substrate 10 and also simplify manufacturing processes.

It can be understood that the electrical field shielding layer 103 in the embodiment of the present application simultaneously forms the scan lines 1032 and the shielding electrodes 1031. Namely, the electrical field shielding layer 103 in the embodiment of the present application is a scan wiring layer, and it not only forms the scan lines 1032, but also forms the shielding electrodes 1031.

Specifically, the shielding electrodes 1031 comprises a plurality of sub-shielding electrodes 10311. The sub-shielding electrodes 10311 are disposed along the second direction and are spaced at intervals. It should be explained that because the electrical field shielding layer 103 comprises the scan lines 1032 and the shielding electrodes 1031, to make the scan lines 1032 insulated from the shielding electrodes 1032, the shielding electrodes 1031 need to be divided into the sub-shielding electrodes 10311.

For one shielding electrode 1031, the shielding electrode 1031 comprises the sub-shielding electrode 10311, the sub-shielding electrodes 10311 are disposed along the second direction and are spaced at intervals, and one sub-shielding electrode 10311 corresponding to one shielding electrode 1031 is disposed between adjacent two of the scan lines 1032. For the shielding electrodes 1031, each of the shielding electrodes 1031 comprises the sub-shielding electrodes 10311, and the sub-shielding electrodes 10311 corresponding to one shielding electrodes 1031 are disposed along the second direction and are spaced at intervals, and the sub-shielding electrodes 10311 corresponding to the shielding electrode 1031 are disposed between adjacent two of the scan lines 1032.

In the embodiment of the present application, the electrical field shielding layer 103 further comprises a plurality of first connection electrodes 1033. a plurality of first connection electrodes 1033 are disposed along the second direction and are spaced at intervals. One first connection electrode 1033 is disposed between adjacent two of the scan lines 1032, and the sub-shielding electrode 10311 between the adjacent two of the scan lines 1032 is connected to a corresponding one of the first connection electrodes 1033.

Each of the first connection electrodes 1033 has a signal connection terminal disposed on the first connection electrode 1033, and the signal connection terminal is configured to receive electrical signals. In the embodiment of the present application, the sub-shielding electrode 10311 between adjacent two of the scan lines 1032 receives electrical signals through a corresponding one of the first connection electrodes 1033.

The array substrate provided by the embodiment of the present application 10, disposes the shielding electrodes 1031 to right correspond to the data lines 1021 to shield an electrical field generated by charges on the data lines 1021 to prevent interfere with the pixel electrodes causing negative effects such as light leakage and crosstalk. Because the shielding electrodes 1031 right correspond to the data lines 1021, a pixel aperture rate can be improved.

In the embodiment of the present application, a voltage of a signal on the shielding electrode 1031 is less than a minimum value of a voltage of a signal on the data line 1021, or the voltage of the signal on the shielding electrode 1031 is greater than the maximum value of the voltage of the signal on the data line 1021. For example: the voltage of the signal inputted into the data line 1021 is A volts to B volts. The voltage of the signal inputted into the shielding electrode 1031 is less than A volts, or, the voltage of the signal inputted into the shielding electrode 1031 is greater than B volts, and A is less than B. Namely, the voltage of the signal inputted into the shielding electrode 1031 is out of a variable range of the voltage of the signal inputted into the data line 1021.

It should be explained that when the array substrate 10 are formed by four mask processes, a polycrystalline silicon layer is generally disposed under the data wiring layer 102. The embodiment of the present application setting the voltage of the signal inputted into the shielding electrode 1031 out of the variable range of the voltage inputted into the data line 1021 can prevent the polycrystalline layer between the data wiring layer 102 and the electrical field shielding layer 103 from having variation of electrical characteristics due to switch of positive and negative polarities of signals on the data lines 1021 and resulting in fluctuation of the voltage of the signal on the shielding electrode 1031 generating horizontal crosstalk.

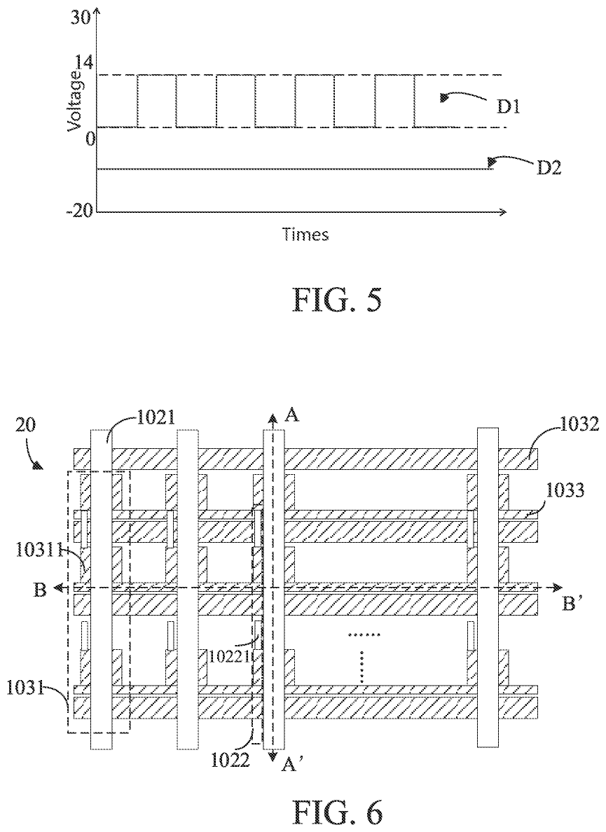

For example, with reference to FIG. 4, FIG. 4 is a schematic voltage-time chart of signals inputted into shielding electrodes and data lines in the array substrate provided by the embodiment of the present application. FIG. 5 is another schematic voltage-time chart of signals inputted into shielding electrodes and data lines in the array substrate provided by the embodiment of the present application. With reference to FIGS. 1, 4, and 5, the voltage of the signal D1 inputted into the data line 1021 is 0 volt to 14 volts, the voltage of the signal D2 inputted into the shielding electrode 1031 can be −20 volt to 0 volt, or, the voltage of the signal D2 inputted into the shielding electrode 1031 can be 14 volts to 30 volts.

With reference to FIG. 6, FIG. 6 is another schematic structural view of the array substrate provided by the embodiment of the present application. A difference of the array substrate 20 in FIG. 6 from the array substrate 10 in FIG. 1 is that: In the array substrate 20 in FIG. 6, the data wiring layer 102 further comprises at least one second connection electrode 1022.

The second connection electrode 1022 and the data lines 1021 are staggered. second connection electrode 1022 comprises a plurality of sub-connection electrodes 10221, a plurality of sub-connection electrodes 10221 are disposed along the second direction and are spaced at intervals, an orthographic projection of the sub-connection electrode 10221 on the electrical field shielding layer 103 is located between adjacent two of the sub-shielding electrodes 10331, the adjacent two sub-shielding electrodes 10331 are connected to each other through the sub-connection electrode 10221.

It should be explained that the embodiment of the present application forms the second connection electrode 1022 on the data wiring layer 102 and makes the second connection electrode 1022 connected to the sub-shielding electrodes 10331 disposed along the second direction and are spaced at intervals such that all of the shielding electrodes 1031 on the array substrate are electrically connected. Hence, the embodiment of the present application only needs to dispose one connection terminal on the array substrate 10, and the connection terminal receives electrical signals.

Furthermore, in the embodiment of the present application, because the width of the shielding electrode 1031 is greater than the width of the data line 1021, the width of the second connection electrode 1022 can be set as a difference between the width of the shielding electrode 1031 and the width of the data line 1021 such that the orthographic projection of the shielding electrode 1031 on the substrate coincides with the orthographic projection of the data line 1021 on the substrate and the orthographic projection of the second connection electrode 1022 on the substrate 101 to improve the pixel aperture rate.

The array substrate provided by the present application, by disposing the shielding electrodes to right correspond to the data lines, shields an electrical field generated by charges on data lines to prevent interference with pixel electrodes causing negative effects such as light leakage and crosstalk. Because shielding electrodes are disposed to right correspond to the data lines, a pixel aperture rate can be improved.

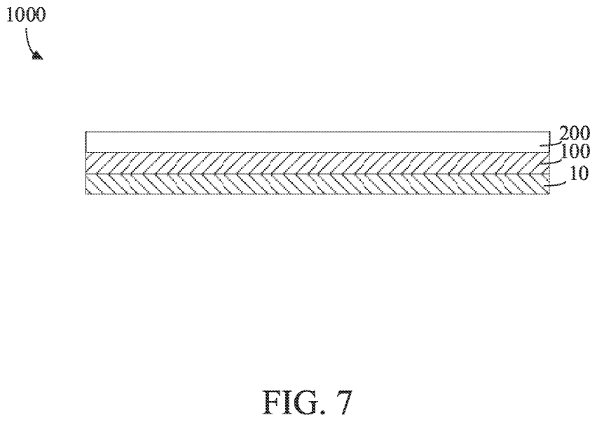

With reference to FIG. 7, FIG. 7 is a schematic structural view of the liquid crystal display panel provided by the embodiment of the present application. As shown in FIG. 7, the liquid crystal display panel 1000 provided by the embodiment of the present application comprises an array substrate 10, an alignment substrate 200, and a liquid crystal layer 100. The alignment substrate 200 is disposed opposite to the array substrate 10. The liquid crystal layer 100 is disposed between the array substrate 10 and the alignment substrate 200.

In an embodiment, alignment substrate 200 can be a color filter substrate. Namely, the liquid crystal display panel 1000 does not dispose the color resist layer on the array substrate 10, but disposes the color resist layer on the alignment substrate 200. In another embodiment, alignment substrate 200 has no color resist layer disposed, and the color resist layer is disposed on the array substrate 10.

In the embodiment of the present application, the array substrate 10 can specifically refer to the array substrate of the above embodiment, which is not described repeatedly here.

The array substrate and the liquid crystal display panel provided by the present application, by disposing the shielding electrodes to right correspond to the data lines, shield an electrical field generated by charges on data lines to prevent interference with pixel electrodes causing negative effects such as light leakage and crosstalk. Because shielding electrodes are disposed to right correspond to the data lines, a pixel aperture rate can be improved.

In the specification, the specific examples are used to explain the principle and embodiment of the present application. The above description of the embodiments is only used to help understand the method of the present application and its spiritual idea. Meanwhile, for those skilled in the art, according to the present the idea of invention, changes will be made in specific embodiment and application. In summary, the contents of this specification should not be construed as limiting the present application.

What is claimed is:

1. An array substrate, comprising:
a substrate;
a data wiring layer disposed on the substrate, wherein the data wiring layer comprises a plurality of data lines, and the data lines are disposed along a first direction and are spaced at intervals; and
an electrical field shielding layer disposed on the substrate, wherein the electrical field shielding layer comprises a plurality of shielding electrodes, an orthographic projection of the shielding electrodes on the substrate at least partially coincides with an orthographic projection of the data lines on the substrate.

2. The array substrate according to claim 1, wherein the shielding electrodes are disposed to right correspond to the data lines.

3. The array substrate according to claim 1, wherein the electrical field shielding layer further comprises a plurality of scan lines, and the scan lines are disposed along a second direction and are spaced at intervals; and
the shielding electrodes comprises a plurality of sub-shielding electrodes disposed along the second direction and spaced at intervals, and one of the sub-shielding electrodes is disposed between adjacent two of the scan lines.

4. The array substrate according to claim 3, wherein the electrical field shielding layer further comprises a plurality of first connection electrodes, the first connection electrodes are disposed along the second direction and are spaced at intervals; one of the first connection electrodes is disposed between adjacent two of the scan lines, and the sub-shielding electrode between adjacent two of the scan lines is connected to the first connection electrode.

5. The array substrate according to claim 4, wherein the data wiring layer further comprises at least one second connection electrode, the second connection electrode and the data lines are staggered; the second connection electrode comprises a plurality of sub-connection electrodes, the sub-connection electrodes are disposed along the second direction and are spaced at intervals, and an orthographic projection of the sub-connection electrode on the electrical field shielding layer is located between adjacent two of the sub-shielding electrodes, and the adjacent two of the sub-shielding electrodes are connected through the sub-connection electrode.

6. The array substrate according to claim 1, wherein a voltage of a signal on the shielding electrode is less than a minimum value of a voltage of a signal on the data line, or a voltage of a signal on the shielding electrode is greater than a maximum value of a voltage of a signal on the data line.

7. The array substrate according to claim 6, wherein the voltage of the signal of the shielding electrode is −20 volt to 0 volt, or, the voltage of the signal of the shielding electrode is 14 volts to 30 volts.

8. The array substrate according to claim 1, wherein the substrate, the electrical field shielding layer, and the data wiring layer are sequentially stacked on one another.

9. The array substrate according to claim 1, wherein the substrate, the data wiring layer, and the electrical field shielding layer are sequentially stacked on one another.

10. A liquid crystal display panel, comprising:
an array substrate;
an alignment substrate disposed opposite to the array substrate; and
a liquid crystal layer disposed between the array substrate and the alignment substrate;
wherein the array substrate comprises:
a substrate;
a data wiring layer disposed on the substrate, wherein the data wiring layer comprises a plurality of data lines, and the data lines are disposed along a first direction and are spaced at intervals; and
an electrical field shielding layer disposed on the substrate, wherein the electrical field shielding layer comprises a plurality of shielding electrodes, an orthographic projection of the shielding electrodes on the substrate at least partially coincides with an orthographic projection of the data lines on the substrate.

11. The liquid crystal display panel according to claim 10, wherein the shielding electrodes are disposed to right correspond to the data lines.

12. The liquid crystal display panel according to claim 10, wherein the electrical field shielding layer further comprises a plurality of scan lines, and the scan lines are disposed along a second direction and are spaced at intervals; and
the shielding electrodes comprises a plurality of sub-shielding electrodes disposed along the second direction and spaced at intervals, and one of the sub-shielding electrodes is disposed between adjacent two of the scan lines.

13. The liquid crystal display panel according to claim 12, wherein the electrical field shielding layer further comprises a plurality of first connection electrodes, the first connection electrodes are disposed along the second direction and are spaced at intervals; one of the first connection electrodes is disposed between adjacent two of the scan lines, and the sub-shielding electrode between adjacent two of the scan lines is connected to the first connection electrode.

14. The liquid crystal display panel according to claim 13, wherein the data wiring layer further comprises at least one second connection electrode, the second connection electrode and the data lines are staggered; the second connection electrode comprises a plurality of sub-connection electrodes, the sub-connection electrodes are disposed along the second direction and are spaced at intervals, and an orthographic projection of the sub-connection electrode on the electrical field shielding layer is located between adjacent two of the sub-shielding electrodes, and the adjacent two of the sub-shielding electrodes are connected through the sub-connection electrode.

15. The liquid crystal display panel according to claim 10, wherein a voltage of a signal on the shielding electrode is less than a minimum value of a voltage of a signal on the data line, or a voltage of a signal on the shielding electrode is greater than a maximum value of a voltage of a signal on the data line.

16. The liquid crystal display panel according to claim 15, wherein the voltage of the signal of the shielding electrode is −20 volt to 0 volt, or, the voltage of the signal of the shielding electrode is 14 volts to 30 volts.

17. The liquid crystal display panel according to claim 10, wherein the substrate, the electrical field shielding layer, and the data wiring layer are sequentially stacked on one another.

18. The liquid crystal display panel according to claim 10, wherein the substrate, the data wiring layer, and the electrical field shielding layer are sequentially stacked on one another.
